(19) United States
(12) Patent Application Publication
(10) Pub. No.: US 2022/0348413 A1
(43) Pub. Date: Nov. 3, 2022

(54) FOOD PRODUCT PROCESSING PLANT AND METHOD

(71) Applicant: Metalquimia, SAU, Girona (ES)

(72) Inventors: Josep Lagares Gamero, Besalu (ES); Federico Scalerandi, Vimercate (IT)

(73) Assignee: Metalquimia, SAU, Girona (ES)

(21) Appl. No.: 17/606,798

(22) PCT Filed: Feb. 13, 2020
(86) PCT No.: PCT/EP2020/053747

§ 371 Date: Oct. 27, 2021

(30) Foreign Application Priority Data
May 2, 2019 (EP) 19382330.9

(51) Int. Cl. B65G 35/06; A22C 18/00; A22C 17/00

(52) U.S. Cl. CPC B65G 35/06; A22C 18/00; A22C 17/0093; A23B 4/052

(57) ABSTRACT

The present invention relates to a food product processing plant including a loading unit (10), one or more processing units (20), and a food product unloading unit (30) that are connected via a rail (41) supporting a plurality of carriages (61) with a hook (62) which are clustered together forming multiple independent trains of carriages (60) which are independently actuated by means of multiple actuating units (51).

### FIELD OF THE ART

According to a first aspect, the present invention relates to a food product processing plant, and according to a second aspect, to a food product processing method in said plant.

The food product is typically filled meat or meat substitute product forming an elongated food product in the form of sausage or the like, and the processing applied will also preferably be processing consisting of baking, cooking, smoking, freezing, thawing, sterilization, etc.

The plant shall consist of a conveying device loading food product into a loading unit, conveying it through one or more processing units where the food product is subjected to one of the processing types described above, or others, during conveyance thereof, and unloading it in an unloading unit once it has been processed.

### STATE OF THE ART

Document U.S. Pat. No. 6,086,469 describes a food product processing plant of the type proposed, including a loading unit, several food product processing units, and an unloading unit that are connected via a conveying device formed by a rail forming a closed loop along which there runs a chain from where there are hung hooks from which the food product in the form of sausage is hung. The hooks are arranged along the chain uniformly and equidistant with respect to one another.

Said chain constitutes an actuating device bringing about the simultaneous movement of all the hooks along the rail.

This solution requires the chain to be extremely long and to have a winding path along the entire rail, which complicates repair and replacement. Furthermore, such a long chain may suffer elongation problems which disrupt the proper operation of the plant. Furthermore, said actuating device does not allow distinct movement of different hooks of the plant, which complicates the regulation and adaptation of the operation of the plant to different types of food products which for example require different processing times in a given processing unit.

Documents CA2984668, US2014315477, and US2005263371 do not describe a processing plant, but rather a loading unit for loading batches of food products into rigid bars for then introducing said rigid bars in processing units.

The loading unit described in the first two documents CA2984668 and US2014315477 includes a closed-loop rail along which there runs a chain from which there hang hooks, similar to the system described in the first document mentioned above.

In these two documents, the hooks are clustered together, leaving some chain segments devoid of hooks.

Since the actuating device of these two documents are identical to that described above and presents the same problems, and since the hooks are actuated by the same actuating device it is impossible to move some hooks separately from the rest of the hook, modifying their separation.

The loading unit described in the third document US2005263371 consists of two parallel closed-loop rails, each one provided with a chain running along the rail and including a segment with hooks, with the rest of the chain being devoid of hooks.

Each rail has hooks arranged in succession in only one segment thereof, the rest of the rail being free for the movement of said hooks.

Therefore, the hooks circulating on one of the rails, actuated by an actuating unit, can move independently of the hooks located in the other rail actuated by another actuating unit, allowing a distinct movement of the hooks on both rails.

The actuating device based on chains parallel to the rails has the same problems as those described in relation to the earlier document from the state of the art. Furthermore, since a rail and an actuating unit are required for each group of hooks, the number of groups of independent hooks is limited and the plant is more expensive.

### BRIEF DESCRIPTION OF THE INVENTION

According to a first aspect, the present invention relates to a food product processing plant.

Food products are understood to mean products intended for being consumed, typically meat products, such as for example sausages or other filled meat products, or meat product substitutes for example made of soybean, or another plant product replacement of meat.

The processing of said food products will be any processing intended for baking, cooking, steaming, smoking, sterilizing, freezing, thawing, or other similar processes applied to said food products.

In a known manner, the present invention proposes that the plant includes:

a food product loading unit, one or more food product processing units, and a food product unloading unit arranged successively and connected via a food product conveying device;

wherein the conveying device includes:

a rail defining a conveyance path going through said one or more processing units;

a plurality of carriages movably supported on said rail, each carriage including a hook configured for hanging food items for the conveyance thereof;

an actuating device configured for driving said plurality of carriages along the rail.

The mentioned processing units are chambers intended for applying a processing to the food product housed therein, which in this case will be continuous processing chambers, for example ovens and/or smokers inside which a high temperature is reached for cooking the food product and/or in which smoke is applied to give the fool product flavor.

The conveying device is in charge of collecting the food product in the loading unit, conveying it through the processing units where it receives the processing described above, and delivering said already processed food product in the unloading unit.

The conveying device consists of a rail on which a plurality of carriages circulate, each one provided with a hook from which the food product is hung for the conveyance thereof along the conveyance path defined by said rail, going through the processing units.

The carriages are supported on the rail such that they can move along its length. Typically this is achieved by means of a stationary continuous rail and including projections made of a material with a low coefficient of friction, such as hard plastic or metal with a minimum surface of contact with the rail, which rest on the rail, allowing the sliding along its length, or by means of wheels attached to the carriage and likewise supported on the rail.

It is optionally contemplated for the carriages forming the trains of carriages to rest, when they are going through an active rail segment, directly on the actuating unit, such that part of said actuating unit acts as a rail in said active rail segment. This solution reduces the components and lowers the cost of the installation. In such case, the passive rail segments will likewise include a stationary rail on which the carriages slide as described above.

In the preferred solution of the actuation units, in which these are formed by a continuous-loop belt tensed between pulleys, the carriages will be held on said belts or hung from same.

Alternatively, the carriages will be supported on the rail both in the active rail segments and in the passive rail segments, and the actuation units will only drive them without bearing the weight thereof.

The food product must therefore be a food product susceptible to being conveyed while hung, i.e., it must consist of elongated elements of a certain length provided with a hooking point susceptible to being hung from a hook. Typically, each batch of food product will be a string of sausages, for example with tens of sausages, which will be hung from multiple hooks of successive carriages forming loops.

Each processing unit will have an inlet and an outlet which said rail goes through, such that the carriages, loaded with food product hung from their hooks, enter through said inlet and are conveyed therethrough until exiting through the outlet. During the time they remain inside the processing unit, the food product will receive said processing.

The length of the rail segment located inside a processing unit, together with the movement speed of the carriages along said rail segment, determines the time during which a specific food product receives processing inside the mentioned processing unit.

The carriages are conveyed along the rail by means of an actuating device in charge of driving them.

The present invention proposes, in a manner that is not known in the existing state of the art, that:

the conveying device includes multiple independent and successive trains of carriages along said rail, each one formed by a cluster of a portion of said carriages arranged in succession and attached to one another by means of articulated attachments, each train of carriages being intended for supporting a batch of food product;

the actuating device includes multiple independently actuated actuating units, configured for driving different trains of carriages located at different positions of the rail, allowing independent and distinct actuation of the multiple trains of carriages; and the rail includes at least one passive rail segment devoid of actuating units.

In other words, the present invention proposes that said carriages with hooks are clustered together, forming multiple successive trains of carriages separated from others, such that each of said trains of carriages may move along the rail autonomously with respect to the rest of the trains of carriages, as they are not attached to one another.

Each train of carriages therefore consists of a plurality of carriages attached to one another by means of an articulated attachment, which allows the train of carriages to be adapted to a curved or sinuous layout of the rail, and also allowing the articulated attachments to transmit tensile stresses between attached carriages, such that it is possible to both accelerate and decelerate said train of carriages by acting on only one of its carriages.

To actuate said trains of carriages, it is proposed that the mentioned actuating device is formed by multiple actuating units susceptible to being actuated independently and configured for driving together the different trains of carriages located at different positions of the rail, i.e., each actuating unit may actuate one or more trains of carriages independently from the rest of the actuating units in charge of actuating the other trains of carriages.

Therefore, there is no actuating device, such as a chain, for example, running along the entire length of the rail, rather the actuating device consists of multiple independent actuating units, allowing for the existence of at least one passive rail segment devoid of an actuating unit. This feature allows preventing the problems associated with the existence of a chain running along the entire length of the rail.

This allows enabling the trains of carriages to be actuated independently, and therefore allows them to move at different times and/or at different speeds along the rail, allowing, for example, the modification of the processing time inside the processing units, creating accumulations of trains of carriages in certain areas in order to adapt to the requirements of the loading unit or of the unloading unit, etc.

Furthermore, this solution allows simplifying plant maintenance, because a defective actuating unit or carriage may be readily identified and repaired or replaced, without having to take apart the entire conveying device, as said device is modular in nature, where said modules are the trains of carriages and the actuating units.

This modular nature also allows enlarging the plant in a simple manner, without the length of the rail entailing any drawback, where said rail may be as long as needed, where different processing units can be located, for example, in different rooms or on different floors of the premises in which the processing plant is located, without this entailing any problem, facilitating the adaptation of the processing plant to any premises.

Another additional advantage of the proposed solution is that even though according to the preferred solution the rail is a closed-loop rail to allow the return of the trains of carriages to the loading unit from the unloading unit, an open rail can be considered in which the trains of carriages are conveyed from the unloading unit to the loading unit by other means, for example stored on a platform with wheels which allows storing them behind the unloading unit and conveying them to the loading unit.

According to a first embodiment of the present invention, it is proposed that the multiple actuating units are distributed along the rail, each being associated with an active rail segment for interacting with one or more trains of carriages located in the corresponding active rail segment causing the movement thereof. In other words, the multiple actuating units are integrated along the rail, associated with active rail segments, such that any train of carriages located in one of said active rail segments is driven by the actuating unit associated with said active rail segment.

A passive rail segment devoid of an actuating unit is interposed between at least two successive active rail segments, with the length of the passive rail segment being less than the length of the trains of carriages. This allows assuring that when the rear end of a train of carriages comes out of an active rail segment, the front end of that same train of carriages has already entered a new active rail segment, such that the mentioned train of carriages will have traction at all times without requiring all the segments of the rail to be active rail segments.

At least one of the actuating units consists of a closed-loop belt with at least one portion parallel to the corresponding active rail segment, said belt being configured for producing, by contact, a pulling of the carriages making up a train of carriages located in said active rail segment.

For example, said closed-loop belt, i.e., a belt having a continuous layout, will be tensed between several pulleys defining, between two of said pulleys, a straight segment which will be parallel to the active rail segment. A train of carriages completely or partially located in said active rail segment will come into contact with the straight segment of the belt.

The belt will be actuated by a motor, for example by a motor connected to one of said pulleys, such that when the belt moves, the train of carriages in contact with the straight segment of the belt will be pulled by said belt, producing the movement thereof.

The mentioned pulling may be due simply to the friction existing between the train of carriages and the belt, although it is also proposed that the belt may include certain relief that is complementary to the relief of the train of carriages, producing an engagement between the belt and the train of carriages, achieving more precise pulling.

Therefore, an actuating unit will comprise a continuous-loop belt which will produce in at least one segment the pulling of the trains of carriages. Optionally, it is contemplated that at least one active rail segment comprises an actuating unit consisting of two symmetrical closed-loop belts on opposite sides of the active rail segment, with each belt being tensed between pulleys with at least one portion parallel to the corresponding active rail segment, with said belts being configured for producing, by contact, a coordinated pulling of the carriages making up a train of carriages located in said active rail segment, thereby achieving a much more precise pulling of the train of carriages.

For the purpose of achieving compact processing units, it is proposed that a plurality of U-shaped active rail segments are arranged adjacent one another, in succession, connected via passive rail segments defining a zigzagging rail area within said one or more food product processing units.

In other words, each of said U-shaped active rail segments shall consist of a first straight rail segment followed by a curved rail segment followed by a second straight rail segment, and wherein the corresponding actuation unit of said U-shaped active rail segment shall consist of a closed-loop belt including a straight portion parallel to the first straight rail segment, followed by a curved portion supported on a pulley and parallel to the curved rail segment, followed by another straight portion parallel to the second straight rail segment.

This zigzag construction of the rail allows achieving a long path inside a processing unit, and therefore a long processing time, at the same time achieving a compact processing unit.

It is alternatively contemplated that the U-shaped active rail segments are connected in succession to one another directly, without interposing a passive rail segment. Preferably, this option will include two symmetrical belts as the actuating unit of each active rail segment, where one and the same belt may have a portion associated with an active rail segment shared with another belt, and another portion associated with another active rail segment and another different belt.

Additionally or alternatively, it is also proposed that the actuating unit of at least one active rail segment consists of a pulley parallel to the corresponding active rail segment, which will be curved, said pulley being configured for producing, by contact, a pulling of the carriages making up a train of carriages located in said curved active rail segment.

According to an alternative embodiment of the actuating device, it is proposed that each train of carriages integrates an actuating unit intended for driving said train of carriages along the rail, said actuating unit moving together with the train of carriages in which it is integrated.

Each actuating unit may regulate its speed and acceleration independently from the rest of the actuating units, allowing each train of carriages to move at a different speed in different segments of the rail, or even stopping in some segments.

In such case, each actuating unit will be preferably a unit operated by electricity, and said electricity may be supplied via the rail, along its length, or alternatively through electric batteries incorporated in the train of carriages itself.

The electric batteries may be charged in one or more recharging segments of the rail configured for charging the electric batteries of the actuating units of the trains of carriages which are located in said recharging segments, or they may be substituted with electric batteries loaded in one or more battery replacement segments configured for substituting the electric batteries of the actuating units of the trains of carriages which are located in said replacement segments.

Each actuating unit may receive control commands, for example wirelessly, or if the current is supplied by the rail, via said rail. Alternatively, the rail may be divided into segments, each being independently electrically powered, allowing the modification of the speed of the trains of carriages circulating through each of said segments by means of controlling the electric current supplied to the actuating units through each of said independent rail segments.

Therefore, according to the two main embodiments described, the actuating device may consist of actuating units integrated in active rail segments, intended for driving any train of carriages passing through said active rail segment, or may alternatively consist of one actuating unit integrated in each of the trains of carriages, driving that train of specific carriages along the entire length of the rail.

One control unit will control all the actuating units by means of control commands for coordinating the movement of all the trains of carriages.

In either of the two cases, it is proposed that the loading unit may consist of a curved rail segment including a loading point associated with a food product supply device, with the actuating units in charge of moving the trains of carriages through said loading point and the food product supply device coordinated for hanging, in an automatic manner, a batch of food product from the hooks of the carriages of each train of carriages passing through said loading point.

Preferably, the hooks of the carriages will be oriented in a direction opposite the conveyance direction, and the mentioned curved rail segment integrating the loading point defines a curvature around a horizontal axis such that the hooks of the trains of carriages circulating through said curved rail segment extend in a radial direction with respect to said horizontal axis. Said curved rail segment will therefore guide the carriages from an upper inverted position, in which the anchoring hooks will be upside down above the carriages, which prevents hanging food product from same, to a lower conveyance position in which the anchoring hooks are upside right below the carriages, which allows retaining food product hung from same.

In the curved rail segment, the separation between radially arranged hooks increases, which facilitates the operation of hanging the food product from same.

Similarly, it is also proposed that the hooks of the carriages are oriented in a direction opposite the conveyance direction, that the unloading unit includes a curved rail segment including an unloading point, wherein the curved rail segment defines a curvature around a horizontal axis such that the hooks of the trains of carriages circulating through said curved rail segment extend in a radial direction with respect to said horizontal axis, said curved rail segment guiding the carriages from a lower conveyance position, in which the hooks hang below the carriages, to an upper inverted position in which the hooks are located above the carriages, bringing about the release and falling of any food product hung from said hooks due to gravity when the hooks arrive at the unloading point.

It is additionally proposed that the conveying device includes one or more accumulation areas in which a certain number of trains of carriages accumulate, for example for adapting the operation of the plant to brief interruptions in the supply of food product in the loading unit, or in the collection of said food product in the unloading unit.

The loading unit receives a supply of an elongated food product, such as sausages, for example, from a filling machine which introduces a food product paste, or ground or minced food product inside an elongated casing, forming a succession of sausages attached at their ends.

The loading unit typically casts said elongated food product while rotating, casting the loops of the elongated product such that the cusp of said loops coincide with the loading point when a hook of a carriage is located in said loading point, such that said loop is hung from the mentioned hook. If operation of the filling machine is interrupted, for example to reload a batch of food product to be filled, the plant can continue to operate in an uninterrupted manner by means of the mentioned use of the accumulation areas for trains of carriages which allow supplying previously accumulated carriages loaded with food product to the processing units, and accumulating empty trains of carriages while waiting for the loading unit to be operative again.

When the actuating units are integrated in the trains of carriages, an accumulation area is enabled in a simple manner and said actuating units are configured for stopping or for reducing their speed in said accumulation areas.

When the actuating units are integrated in active rail segments of the rail it is proposed that each accumulation area comprises an active rail segment provided with an actuating unit incorporating:
a ratchet-like engaging mechanism set to disengage when another train of carriages located in the rail impedes or delays the forward movement of a train of carriages located in said accumulation area, allowing their accumulation, and for driving said train of carriages when there is no obstacle in the rail, or
a friction connection with the trains of carriages configured for slipping when another train of carriages located in the rail impedes or delays the forward movement of a train of carriages located in said accumulation area, allowing their accumulation, and for driving said train of carriages when there is no obstacle in the rail.

Either of these two embodiments allows, when there is an accumulation of trains of carriages stopped on the rail, the next trains of carriages to be stopped without requiring sophisticated detection and control systems for the actuating units located in said accumulation area, rather the actuating units will simply remain active but will not transmit movement to the trains of carriages as a result of the mentioned engaging mechanism or the low coefficient of friction existing between the belts of the actuating units and the trains of carriages which allows them to slip without transmitting movement when the train of carriages resists against the forward movement.

According to the preferred embodiment of the rail, said rail consists of two parallel partial rails, with each carriage being supported on both parallel partial rails, the corresponding conveyance hook hanging between both partial rails, achieving that the weight of the food product is centered and distributed between the two partial rails in a homogeneous manner.

It is also proposed that each carriage of each train of carriages preferably includes:
a crosspiece formed by a vertical shaft and by a horizontal shaft which is articulated with respect to the carriage on either side of the crosspiece;
a first yoke with two first wings surrounding the crosspiece, the horizontal shaft being articulated with respect to said two first wings;
a second yoke with two second wings surrounding the crosspiece of an adjacent carriage, the vertical shaft of the crosspiece of the adjacent carriage being articulated with respect to said two second crosspieces; and wherein
the second yoke is of a smaller size than the first yoke, both being configured so that the second yoke of a carriage is housed between the crosspiece and the first yoke of an adjacent carriage.

The hook will be integrally attached to the vertical shaft of the crosspiece, or optionally to the body of the carriage.

Therefore, each carriage will include a first yoke and a second yoke, the first yoke supporting the horizontal shaft of the crosspiece between its two first wings, and the second yoke attached in an articulated manner to the vertical shaft of another crosspiece of an adjacent carriage of the train of carriages, the second yoke being housed loosely inside the first yoke of the mentioned adjacent carriage.

Each crosspiece, and the corresponding first and second yokes thus have a construction similar to a universal joint.

Therefore, each crosspiece of the train of carriages acts like an articulated attachment between two adjacent carriages, allowing two degrees of freedom in the form of rotation around the vertical shaft allowing the train of carriages to follow a winding layout with defined curves when seen from above, and of rotation around the horizontal shaft allowing the train of carriages to follow a winding layout with defined curves when seen in elevation.

According to a second aspect, the present invention relates to a food product processing method in a processing plant like the one described above.

The proposed method includes the following steps, which are known in the existing state of the art:
loading multiple batches of food product on the hooks of the carriages in the loading unit;
conveying the batches of food product through one or more food product processing units by means of the movement of the carriages driven by an actuating device, applying processing to said batches of food product;
unloading said batches of food product from the hooks of the carriages in the unloading unit, after processing thereof;
conveying the carriages back to the loading unit by means of the actuating device.

The method of the present invention further proposes, in a manner that is not known in the existing state of the art, that:
each batch of food product is located in an independent train of carriages formed by a portion of the carriages attached to one another in an articulated manner; and
each train of carriages is actuated independently from the rest of the trains of carriages by means of transmitting distinct control commands to each one of a plurality of actuating units making up the actuating device, the actuating units being configured for driving different trains of carriages located at different positions of the rail.

In other words, it is proposed that each batch of foods is conveyed through the plant hung from the hooks of carriages connected to one another in an articulated manner forming a train of carriages, and that each of said trains of carriages may be conveyed through the plant by means of an independent control, driven by the multiple actuating units constituting the actuating device.

This allows each batch of food product to be conveyed through the plant independently from the conveyance of the rest of the batches, which allows adapting the production to different needs of the different batches of food product or to different needs of plant logistics.

It is also contemplated that rails may be installed on different levels, which allows for example superimposing processing units on two levels, with one rail passing through the lower level of processing units and another rail passing through the upper level of processing units, which allows doubling production with the same surface area.

In this case, preferably the loading unit and optionally also the unloading unit of both rails will be on the lower level, and the rail may include an ascending segment for raising the batches of food product to the upper level for processing, and a descending segment for returning the trains of carriages and the already processed food product they convey to the lower level for unloading.

There can be included a loading unit and an unloading unit which is independent for each rail, such that each rail is separated from the other rails, but it is also contemplated that a single loading unit may feed the two superimposed rails, or a single unloading unit may process trains of carriages coming from the two superimposed rails.

It will be understood that references to geometric positions, such as, for example, parallel, perpendicular, tangent, etc., allow deviations of up to ±5° with respect to the theoretical position defined by said nomenclature.

It will also be understood that any range of values that is offered may not be optimal as regards its end values and may require adaptations of the invention so that said end values are applicable, with said adaptations being within reach of one skilled in the art.

Other features of the invention will become apparent in the following detailed description of an embodiment.

### BRIEF DESCRIPTION OF THE DRAWINGS

The foregoing and other advantages and features will be more fully understood based on the following detailed description of an embodiment in reference to the attached drawings which must be interpreted in an illustrative and non-limiting manner, in which:

FIG. 1 shows a schematic side elevational view of a plant like the one proposed, provided with a loading unit, two processing units, an unloading unit, an accumulation area, and a closed-loop rail communicating them, according to a first embodiment in which multiple actuating units are distributed along the rail and associated with active rail segments for producing the movement of the different independent trains of carriages distributed along the rail;

FIG. 2 shows an enlarged view of a part of the rail shown in FIG. 1, including the part of the rail going through the loading unit, showing how the rail includes an inverted segment in which the carriages circulate upside down with the corresponding hooks protruding upwards in the inverted position, a curved segment comprising the loading point at which the carriages are inverted and loaded with the food product, and a non-inverted segment in which the trains of carriages circulate upside right with the hooks hanging below same;

FIG. 3a shows a schematic plan view of an embodiment similar to the one shown in FIG. 1 but in which the rail has a zigzag layout both inside the processing units and in the accumulation area, according to a first embodiment in which each active rail segment is associated with a single actuating unit;

FIG. 3b shows the same as FIG. 3a, but according to a second embodiment in which the actuating unit of some of the active rail segments has two symmetrical continuous-loop belts, such that a train of carriages located in said active rail segment located between the two belts which simultaneously actuate it will be pulled in a precise manner;

FIG. 3c shows the same as FIG. 3b, but according to a third embodiment in which in some active rail segments located between two continuous-loop belts the rail is made up of only said symmetrical belts, the trains of carriages being held and supported directly by said belts;

FIG. 4 shows a schematic side elevational view of a plant like the one proposed, provided with a loading unit, two processing units, an unloading unit, an accumulation area, and a closed-loop rail communicating them, according to a second embodiment in which multiple actuating units are each attached to a train of carriages for producing the movement of the different independent trains of carriages distributed along the rail, each one moving together with its corresponding actuating unit;

FIG. 5 shows a detailed perspective view of a carriage according to a preferred embodiment, showing with a discontinuous line two adjacent carriages of the train of carriages attached to said carriage;

FIG. 6 shows a cross-section view of a train of carriages like the one shown in FIG. 5, supported on a rail formed by two partial rails, the cross-section being established by a vertical plane which sections the first and the second yokes attached to a crosspiece, but without sectioning the mentioned crosspiece.

### DETAILED DESCRIPTION OF AN EMBODIMENT

The attached drawings show illustrative and non-limiting embodiments of the present invention.

According to a preferred embodiment, the proposed processing plant consists of a conveying device in charge of conveying batches of food product in the form of sausages along the plant, collecting said food product in a loading unit 10, conveying it through one or more processing units 20, and delivering it in an unloading unit 30.

The processing units 20 can be, for example, an oven or a smoker, provided with a shell with an inlet opening and an outlet opening which the conveying device 10 goes through, inside which processing is applied to the food product, for example, processing by using heat or by smoking.

The mentioned conveying device consists of a closed-loop rail 41 through which there circulate multiple trains of carriages 60, independent of each other, in succession. The closed-loop rail 41 allows the trains of carriages 60 to move forward from the loading unit 10 to the unloading unit 30 along a conveyance path which occupies part of the closed loop, and to continue moving forward from the unloading unit 30 to the loading unit 10, along a return path which occupies the rest of the closed loop. The rail will include, along said return path, a cleaning unit for cleaning the trains of carriages.

Each train of carriages 60 consists of individual carriages 61 connected to one another by means of articulated attachments 63 which allow transmitting tensile and compression stresses between connected carriages 61.

Each carriage 61 includes projections 67 with a low coefficient of friction with a small surface of contact with the rail 61, or wheels 67 which support the carriage 61 on the rail 41, allowing its sliding movement along said rail 41, and it also includes a hook 62 attached to said carriage 61 from which a food product in the form of sausage can be hung. Preferably, said projection with a low coefficient of friction will be made of metal or rigid plastic with a high hardness and will have a circular shape, defining a single point of contact with the rail 61.

The preferred embodiment of the trains of carriages 60 is formed by carriages 41 attached to one another by means of articulated attachments 63 formed by crosspieces 66 from which the hooks 62 hang, each hook 62 being integral with one of the crosspieces 66.

The carriages 61 will be shaped like links of a chain, each carriage being attached in an articulated manner to one crosspiece 66 at one end and to another crosspiece 66 at the other opposite end.

The proposed crosspiece 66 is formed by a vertical shaft 66V, which extends until being connected with the hook 62, and by a horizontal shaft 66H. Each carriage 41 will have a first yoke 64 at one end that will surround the crosspiece 66 with two first wings 64a and 64b which in turn will be attached in an articulated manner to the horizontal shaft 66H, and a second yoke 65 at an opposite end that will surround another crosspiece 66 with two second wings 65a and 65b which in turn will be attached in an articulated manner to the vertical shaft 66V of said other crosspiece 66.

The second yoke 65 will have a smaller size than the first yoke 64, such that a second yoke 65 of a carriage 61 may be loosely housed between the crosspiece 66 and the first yoke 64 of another carriage 61, allowing the articulation of one carriage 61 with respect to the other one around the two vertical and horizontal shafts 66V and 66H similarly to a universal joint.

Evidently, the invention also contemplates the inverse construction, which is considered equivalent, in which the first yoke 64 is smaller than the second yoke 65, the first yoke 64 being housed between the crosspiece 66 and the second yoke 65.

According to the preferred embodiment, the rail 41 consists of two parallel partial rails 41a and 41b , with each carriage 61 being supported simultaneously on both partial rails 41a and 41b , the hook 62 being located between both partial rails 41a and 41b . This allows proper distribution of the weight of the food product on the rail 41.

It is also contemplated that the ends of the horizontal shaft 66H emerge from the carriage 61 on both sides, defining the projections with a low coefficient of friction which are in contact with the two parallel partial rails 61a and 61b for supporting and guiding the carriages 61 along the rail 41.

For producing the movement of the trains of carriages 60 along the rail 41, the plant incorporates an actuating device 50 which is proposed to consist of multiple independent actuating units 51 which allow driving in a distinct manner the different trains of carriages 60 distributed along the rail 41.

Therefore, the actuating device 50 does not extend along the entire length of the rail 41, but rather the actuating units 51 act on the different trains of carriages 60 on rail 60 including passive rails segments 42 devoid of actuating units 51.

The independent actuation of the different trains of carriages 60 allows modifying their speeds in different segments of the rail 41, thereby achieving that they stay for a longer or shorter time in a given processing unit 20, or even allowing different batches of food product to receive processing for a different duration in the same plant without needing to adapt the mentioned plant, but rather by simply regulating in a different manner the different actuating units 51.

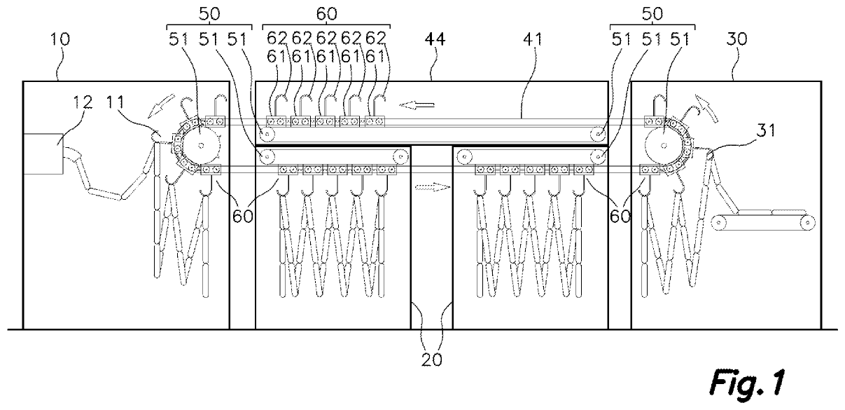

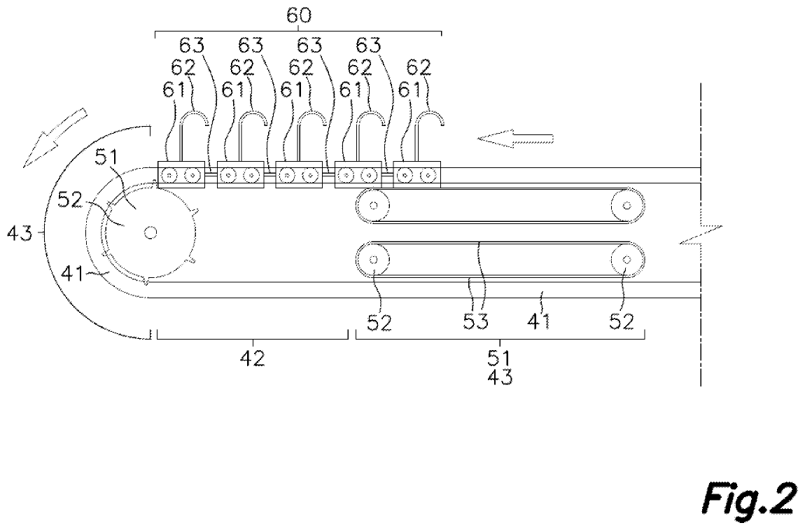

According to the first proposed embodiment shown in FIG. 1, the actuating units 51 are associated with active rail segments 43 of the rail 41, distributed along the length thereof, for driving the trains of carriages 60 which are located in said active rail segments 43.

Each actuating unit 51 may consist, for example, of a continuous-loop belt 53 tensed between pulleys 52 defining one or more segments parallel and adjacent to an active rail segment 43, said segment being configured for contacting with parts of the carriages 41 circulating through the active rail segment 43 producing the pulling thereof.

A motor will actuate one of the pulleys 52 producing the movement of the belt and also the movement of any train of carriages 60 in contact with same, driving it in the conveyance direction.

Since the carriages 61 of each train of carriages 60 are connected to one another by means of an articulated attachment 63, even if just one of the carriages 61 contacts with the actuating unit 51 movement of the entire train of carriages 60 is produced.

It is advisable for the length of the passive rail segments 42 located between two active rail segments 43 to have a smaller length than the length of the trains of carriages 60, such that it is assured that a train of carriages 60 will always be at least partially in contact with an active rail segment 43, thereby preventing being jammed in a passive rail segment 42. This feature may be omitted, for example, when the passive rail segment 42 is on a slope, which allows assuring that a train of carriages 60 will move through it without requiring actuating units 51.

The mentioned belt 53 can be a rough belt or include protrusions at predefined intervals, complementary with a relief included on the trains of carriages 60, thereby allowing engagement between the belt 53 and the pulled trains of carriages 60, thus assuring precise movement. A similar result can be achieved with a smooth belt 53 made of material with a high coefficient of friction, such as gum, rubber, or the like.

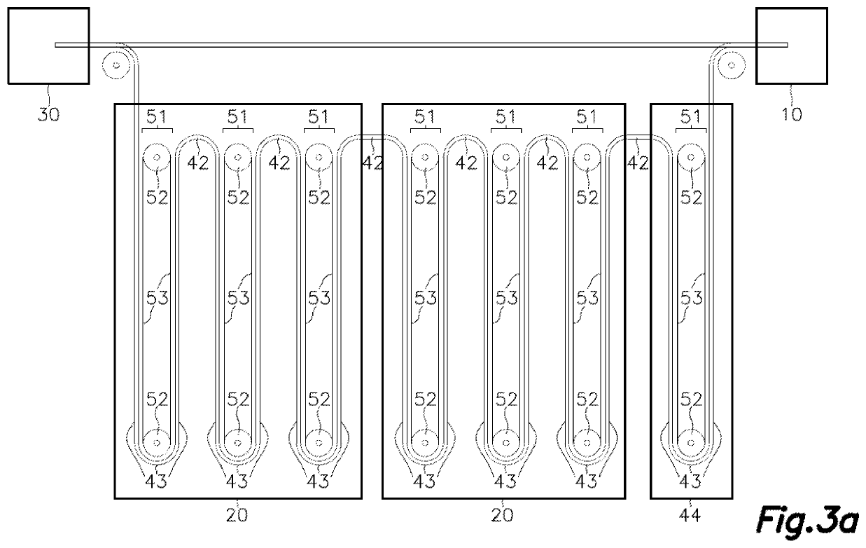

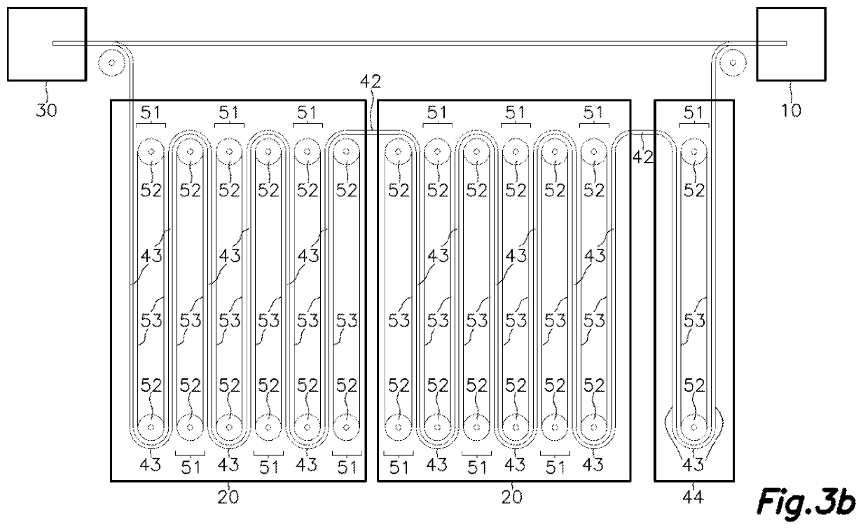

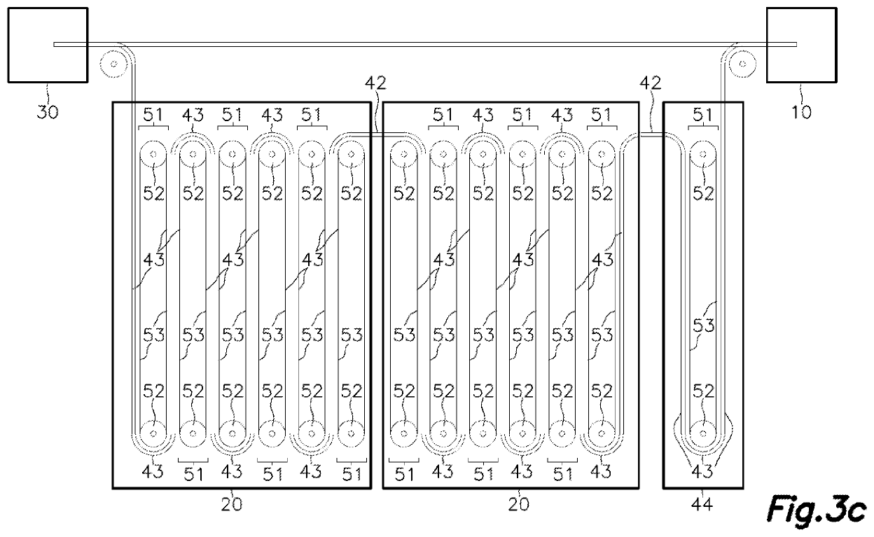

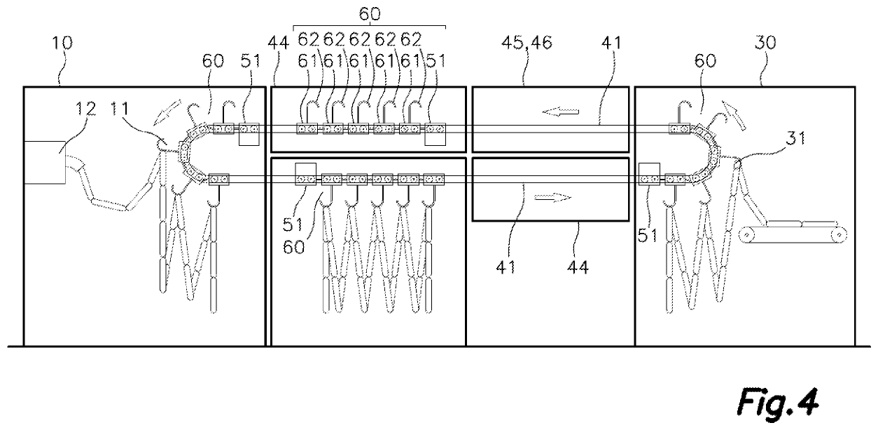

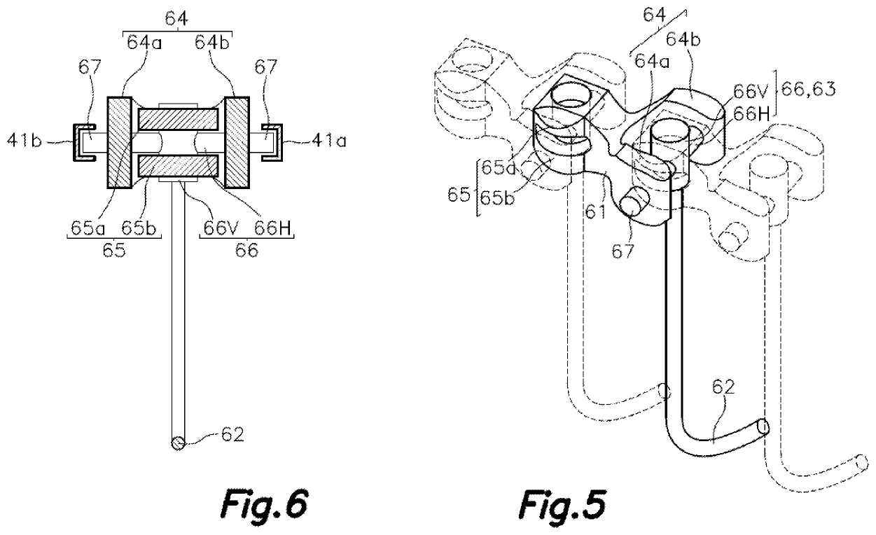

According to a preferred embodiment shown in FIGS. 3a and 3b, the rail 41 will have, inside the processing units 20, a zigzag path for the purpose of prolonging its length inside the processing units 20, therefore prolonging the time during which the food product remains inside the processing unit 20.

The mentioned zigzag layout of the rail 41 consists of parallel straight segments attached by semicircular segments. In the case shown in FIG. 3a, it is proposed that the active rail segments 43 are formed by two of said consecutive straight segments and the semicircular segment connecting them, the corresponding actuating unit 51 being formed by a closed-loop belt 53 tensed between two pulleys 52, two straight segments of the belt 53 being parallel and adjacent to the two straight segments of the active rail segment 43 and one of the pulleys 52 being concentric with the semicircular segment of the active rail segment 43, such that the belt 53 is also parallel and adjacent to the mentioned semicircular segment of the rail 41.

By repeating this construction multiple times, connecting each of said active rail segments 43 with semicircular passive rail segments 42, the mentioned zigzagging circuit is obtained.

It is alternatively contemplated that, as shown in FIG. 3b, each active rail segment 43 is associated with two symmetrical actuating units 51 located on either side of the active rail segment 43. Each of the actuating units will have a construction identical to that previously described, formed by pulleys 52 and a continuous-loop belt 53 tensed between said pulleys 52, such that the straight segments of the belts 53 of the two symmetrical actuating units 51 will be simultaneously in contact with a train of carriages 60 located in the active rail segment 43, producing the pulling thereof in a precise and controlled manner.

According to another further alternative embodiment shown in FIG. 3c, it is contemplated that in those active rail segments comprised between two symmetrical belts constituting the actuating unit thereof, the rail will be constituted only by said symmetrical belts, with the trains of carriages being supported only on said belts when they are in said active rail segment.

In this embodiment, in those segments in which two symmetrical belts do not exist, for example, as it is a passive rail segment or an active rail segment provided only with a single belt or another type of non-symmetrical actuating unit, it will be necessary to provide a rail that is not made up of said actuating unit, for example a stationary rail on which there move trains of carriages which will have to be transferred from one type of rail to the other while they are moving.

It is also contemplated that the belt 53 may be smooth and made of a material with a low or calibrated coefficient of friction so as to allow pulling a train of carriages 60 in contact therewith only when there is no obstacle on the rail 60, i.e., when there is no other train of carriages 60 after it. For example, said belt can be made of a flexible plastic material with a smooth finish. The geometry of the belt may also affect the surface of contact between said belt and the train of carriages 60, for example a wide belt will have a larger surface of contact and therefore higher grip than a narrow belt or even one with a cylindrical section, which is the shape that most reduces the surface of contact and therefore the grip between the belt and the train of carriages 60.

This feature allows the trains of carriages 60 to accumulate in the active rail segment 43 provided with the mentioned smooth belt 53 when there is a retention on the rail 41, thus constituting an accumulation area 44 of trains of carriages 60, without needing to apply a precise control of the actuating unit 51 of said smooth belt 53 which allows stopping it when said accumulation exists, simply limited to the belt 53 slipping on the accumulated trains of carriages 60 without producing the movement thereof.

A similar effect may be achieved by including an engaging mechanism between the motor and the pulley 52 actuated by said motor, with the engaging mechanism being tared to obtain the result described above, despite using a rough belt 52 or with a high coefficient of friction.

The accumulation areas 44 before the loading unit 10 are of particular interest, as it allows having a supply of stored trains of carriages 60 for loading batches of food product at any time needed, adapting to possible brief interruptions in the supply of food product.

It is also of interest to use accumulation areas 44 before the unloading unit 30, which allows adapting the unloading rate to different needs other than those of the proposed processing plant, such as for example the different needs of a packaging machine located after the unloading unit.

It is also proposed that one of the actuating units 51 may consist of only one pulley 52, part of which is adjacent and parallel to a curved active rail segment 43, such that said pulley 52 contacts with the carriages 61 of a train of carriages 60 located in said curved active rail segment 43, dispensing with the mentioned belt 53. The features of the coefficient of friction of the mentioned pulley 52 and its roughness may be equivalent to those described in relation to the belt 53, achieving an equivalent result.

According to an alternative embodiment, the actuating units 51 are not associated with the rail 41, but rather they are associated with the trains of carriages 60. In other words, each train of carriages 60 integrates an actuating unit 51 which drives and moves together with the train of carriages 60 along the rail 60. In such case, the entire rail 41 must be considered a passive rail segment 42, since the rail 41 does not push the trains of carriages 60 at all.

It is considered for example that each actuating unit 51 is provided with an electric motor connected to drive wheels supported on the rail 41, said actuating unit being attached to the rest of the train of carriages 60 by means of an articulated attachment 63, such that the actuating unit 51 may slide over the rail 41, actuating the motor and producing the pulling or pushing of the rest of the train of carriages 60.

Each actuating unit 51 may receive specific control commands, be programmed with a given routine, or receive control commands depending on the position of the corresponding train of carriages 60 inside the rail 41.

It is also contemplated that the actuating units 51 may be configured for stopping or slowing down the speed of the trains of carriages 60 in a given area of the rail 41, turning said area into a storage area 44 for trains of carriages 60.

The actuating unit 51 may receive power supply and/or control instructions through the rail 41, which in such case would include conductive tracks along its length to which the actuation unit 51 would be connected by means of sliding electric contacts such as brushes, for example.

Different segments of the rail may have conductive tracks independent of one another which allow regulating the speed of the actuating units 51 in a distinct manner in each of said independent segments by means of the distinct regulation of the energy transmitted through said conductive tracks in each of the mentioned independent segments.

It is alternatively contemplated that each actuating unit 51 may incorporate an electric battery which supplies energy during the movement thereof. In such case, for the purpose of recharging the electric batteries, the rail 41 must include one or more recharging segments 45 configured for recharging the electric batteries of the trains of carriages 60 located in said recharging segments 45. A recharging segment may include for example conductive tracks to which the actuating unit 51 will be connected by means of electric contacts, preferably sliding electric contacts such as brushes, while the train of carriages 60 remains in said recharging segment 45. The recharging segments 45 may coincide with the accumulation areas 44.

In the event of using electric batteries, it is contemplated that the rail 41 may include one or more battery replacement segments 46 in which the fully or partially discharged batteries of the actuating units 51 are substituted with fully charged batteries. Said replacement of the batteries can be done by hand, by an operator, or automatically by means of a battery replacement device in charge of taking out the depleted battery, introducing it in a battery charger, taking out another previously charged battery from the battery charger, and inserting said charged battery in the actuating unit 51, for example by means of a robotic arm.

According to a preferred embodiment of the loading unit 10, said unit includes a food product supply device 12, proposed to be a head that expels the food product in the form of sausage, casting it into the air while at the same time the head rotates around a horizontal axis, such that the food product is expelled forming loops. The rail 41 going through said loading unit 10 defines a loading point 11 at which a hook 62 of a train of carriages 60 is located for, in coordination with the supply device 12, coinciding with the apex of each loop of the food product expelled in the moment in which said zenith is falling, such that said zenith falls inside the hook 62 with that loop of food product being hung from that hook 62. The train of carriages 60 will move through the loading unit 10 such that each of its hooks 62 passes through the loading point 11 in the precise moment for collecting one of the loops of the food product expelled by the supply device 12.

The loading point 11 will preferably be located in a semicircular segment of the rail 41, concentric to a horizontal axis. The trains of carriages 60 will arrive at said semicircular segment from an inverted rail segment in which the trains of carriages 60 circulate upside down, the hooks 62 being in the inverted position, and come out of same through a non-inverted rail segment in which the trains of carriages 60 circulate in the normal position, with the hooks 63 hanging downwards, and the trains of carriages 60 will circulate with the hooks 62 oriented in the direction opposite the direction of forward movement of the train of carriages 60.

Therefore, when the trains of carriages 60 circulate through the semicircular segment, the hooks extend radially with respect to said horizontal axis, being separated from one another and facilitating the food product engaging the hook 62 located at the loading point 11, and the hooks 62 located at the loading point 11 being oriented upwards for receiving the falling food product.

Preferably, the semicircular segment including the loading point 11 will be an active rail segment 43 in which the corresponding actuating unit 51 engages with the train of carriages 60 for producing precise movement of said train of carriages 60.

The unloading unit 30 also includes a curved segment around a horizontal axis and comprising an unloading point 31. The curved segment receives trains of carriages 60 loaded with food product circulating in the non-inverted position the hooks 62 of which, when they go through the curved segment, transition from hanging vertically to extending radially around the horizontal axis, being separated from one another and tilting until reaching the horizontal when they go through the unloading point 31, which brings about the food product falling from the corresponding hook 62. After going through the curved segment, the trains of carriages 60 are in the inverted position.

It will be understood that the different parts constituting the invention described in an embodiment can be freely combined with parts described in other different embodiments even though said combination has not been explicitly described, provided that such combination is not detrimental.

1. A food product processing plant comprising:
a food product loading unit, one or more food product processing units, and a food product unloading unit successively disposed and connected via a food product conveying device;
the conveying device comprising:
a rail defining a conveyance path through said one or more food processing units;
a plurality of carriages movably supported on said rail, each one of said plurality of carriages comprising a hook configured for hanging food items for the conveyance thereof; and
an actuating device configured for driving each one of said plurality of carriages along said conveyance path;
said actuating device comprising a plurality of independently actuated actuating units each one configured for driving different ones of said plurality of carriages located at different positions of the conveyance path and to allowing independent and distinct actuation thereof; and
said rail comprising at least one passive rail segment devoid of actuating units;
a plurality of independent and successive trains of carriages disposed along said rail, each one of said plurality of independent and successive train of carriages being formed by a cluster of a portion of said plurality of carriages and disposed in succession and attached to one another by articulated attachments, each one of said plurality of independent and successive train of carriages configured to support a batch of food product.

2. The processing plant according to claim 1, wherein each one of said plurality of actuating units are distributed along said conveyance path and are associated with one of a group of active rail segments interacting with one or more of said plurality of independent and successive trains of carriages located in a corresponding one of said group of active rail segments causing a movement of each one of said plurality of independent and successive said train of carriages, with said at least one passive rail segment being located between two active rail segments and a length of said at least one passive rail segment being less than a length of said plurality of independent and successive trains of carriages.

3. The processing plant according to claim 2, wherein at least one of said group of active rail segments comprises an actuating unit consisting of two symmetrical closed-loop belts on opposite sides of said at least one of said group of active rail segments, with each one of said two symmetrical closed—loop belts being tensed between pulleys with at least one portion parallel to the corresponding one of said group of active rail segments, with each one of said two symmetrical closed-loop belts being configured for producing, by contact, a coordinated pulling of each one of said plurality of carriages defining said plurality of independent and successive a train of carriages located in said-at least one of said group of active rail segment.

4. The processing plant according to claim 3, wherein a each one of a plurality of said group of active rail segments comprise a U-shape and are adjacently disposed to and connected in succession to one another AM defining a zigzagging rail area within said one or more food product processing units.

5. The processing plant according to claim 2, wherein said actuating unit of at least a curved one of said group of active rail segments consists of a pulley disposed in parallel to a corresponding curved one of said group of active rail segments, with said pulley being configured for producing, by contact, a pulling of the each one of said plurality of carriages defining said plurality of independent and successive train of carriages located in said one of said group of active rail segments.

6. The processing plant according to claim 2, wherein said conveying device comprises one or more accumulation areas each one comprising one of said group of active rail segments provided with one of said plurality of actuating units incorporating:
an engaging mechanism configured to disengage when another one of said plurality of independent and successive train of carriages located in the said rail impedes or delays a forward movement of at least one of said plurality of independent and successive a train of carriages located in said accumulation area, allowing the accumulation of individual ones of said plurality of independent and successive train of carriages without stopping the said actuating unit; and said engaging mechanism configured to drive said plurality of independent and successive train of carriages when there is no obstacle in said rail, or
a friction connection operatively enabled with each one of said plurality of independent and successive trains of carriages and configured for slipping when another one of said plurality of independent and successive train of carriages located in said rail impedes or delays said forward movement of said plurality of independent and successive train of carriages (60) located in said accumulation area (44), allowing the accumulation of said plurality of independent and successive train of carriages without stopping said actuating unit, and for driving said plurality of independent and successive train of carriages when there is no obstacle in said rail.

7. The processing plant according to claim 1, wherein each one of said plurality of independent and successive train of carriages comprises an actuating unit configured to drive and move together with each one of said plurality of independent and successive train of carriages along said rail; said passive rail segment occupying all or most of a length of said rail.

8. The processing plant according to claim 7, wherein
each actuating unit is configured to receive a power supply through said rail; or
each actuating unit comprises an electric battery configured to power said actuating unit, said rail comprising one or more recharging segments configured for charging said electric batteries of said actuating units of said plurality of independent and successive trains of carriages located in the recharging segments; or
each actuating unit comprising an electric battery configured to power said actuating unit, said rail comprising one or more battery replacement segments configured for substituting said electric batteries of said actuating units of said plurality of independent and successive trains of carriages which are located in said battery replacement segments with another charged electric battery.

9. The processing plant according to claim 1, wherein said rail of said loading unit comprises a curved segment with a loading point associated with a food product supply device, with said actuating units configured to move said plurality of independent and successive trains of carriages located in said loading point and said food product supply device for hanging, in an automatic manner, a batch of food products from said hooks of corresponding ones of said plurality of carriages passing through said loading point and being coordinated with one another.

10. The processing plant according to claim 9, wherein said hooks of the said plurality of carriages are oriented in a direction opposite to the conveyance direction; said curved rail segment comprising said loading point; said loading point configured to define a curvature around a horizontal axis such that said hooks of individual ones of said plurality of independent and successive trains of carriages circulating through said curved segment extend in a radial direction with respect to said horizontal axis, said curved segment configured to guide each one of said plurality of carriages from an upper inverted position, in which said hooks are disposed upside down; said upper inverted position configured to prevent the food product from hanging on a lower conveyance position in which said hooks are disposed upside right I said upper inverted position configured to allow retaining the food product hung from same.

11. The processing plant according to claim 1, wherein said hooks of each one of said plurality of carriages are oriented in a direction opposite to the conveyance direction, and said rail included in said unloading unit comprises a curved segment with an unloading point, said curved segment defining a curvature around a horizontal axis such that said hooks of said plurality of independent and successive train of carriages circulating through said curved segment extend in a radial direction with respect to said horizontal axis, said curved segment guiding each one of said plurality of carriages from a lower conveyance position to an upper inverted position causing the release and falling of any food product hung from said hooks.

12. The processing plant according to claim 1, wherein said rail consists of two parallel partial rails, each one of said plurality of carriages being supported on both of said two parallel partial rails with a corresponding one of said hooks hanging between both partial rails.

13. The processing plant according to claim 1, wherein each one of said plurality of carriages of each one of said plurality of independent and successive train of carriages comprises:
a first yoke with two first wings surrounding a crosspiece formed by a vertical shaft and by a horizontal shaft, said horizontal shaft being articulated with respect to said two first wings;
a second yoke with two second wings surrounding said crosspiece of an adjacent one of said plurality of carriages, said vertical shaft of said crosspiece of said adjacent one of said plurality of carriages being articulated with respect to said two second wings; and
said second yoke comprising a smaller size than said first yoke, both of said first yoke and said second yoke configured so that said second yoke of one of said plurality of carriages is housed between said crosspiece and said first yoke of an adjacent one of said plurality of carriages.

14. A method for processing a food product in a processing plant according to claim 1, the method comprising the following stops:
loading a plurality of batches of the food product on the hooks of the carriages in the loading unit;
conveying the batches of the food product through one or more food product processing units by the movement of the carriages driven by an actuating device, applying processing to the batches of food product;
unloading the batches of food product from the hooks of the carriages in the unloading unit, after processing thereof;
conveying the carriages back to the loading unit by the actuating device;
the loading of each batch of food product being performed in single one of a plurality of independent and successive train of carriages formed by at least some of the plurality of carriages attached to one another by articulated attachments;
the actuation of each one of the plurality of independent and successive train of carriages being performed independently from the rest of the plurality of independent and successive train of carriages by transmitting distinct control commands to each one of a plurality of actuating units defining the actuating device, the actuating units configured for driving different ones of said plurality of independent and successive train of carriages located at different positions of the rail.
